(19) United States
(12) Patent Application Publication
(10) Pub. No.: US 2026/0153293 A1
(43) Pub. Date: Jun. 4, 2026

(54) DEVICE FOR GUIDING AT LEAST TWO FLUID STREAMS, ELECTROCHEMICAL SYSTEM, AND METHOD FOR PRODUCING A DEVICE WITH A HEAT TRANSFER ELEMENT

(71) Applicant: Rolls-Royce Solutions GmbH, Friedrichshafen (DE)

(72) Inventors: Jörn Wildhagen, Ravensburg (DE); Martin Wiedmann, Reichenau (DE); Friedrich Fröhlig, Ulm (DE); Michael Kniepkamp, Friedrichshfen (DE); Claudia Riedel, Friedrichshafen (DE)

(73) Assignee: Rolls-Royce Solutions GmbH, Friedrichshafen (DE)

(21) Appl. No.: 19/463,953

(22) Filed: Jan. 29, 2026

Related U.S. Application Data
(63) Continuation of application No. PCT/EP2024/072655, filed on Aug. 9, 2024.

(30) Foreign Application Priority Data
Aug. 10, 2023 (DE) 10 2023 121 426.8
Aug. 9, 2024 (WO) PCT/EP2024/072655

(51) Int. Cl. F28F 7/02; C25B 15/021; H01M 8/04007

(52) U.S. Cl. CPC F28F 7/02; C25B 15/021; H01M 8/04067

(57) ABSTRACT

A device for guiding at least two fluid streams includes: a heat transfer element, which includes a gyroidal structure, which includes a main gyroid and a secondary gyroid intersecting to form an interleaved gyroid thereby forming at least a first channel system and a second channel system and an interstitial space system, the first channel system and the second channel system each including a first passage width, the interstitial space system including a second passage width, the first channel system and the second channel system being spatially separated from the interstitial space system, the interstitial space system including a support structure that penetrates other portions of the interstitial space system.

### CROSS REFERENCE TO RELATED APPLICATIONS

This is a continuation of PCT application no. PCT/EP2024/072655, entitled “DEVICE FOR GUIDING AT LEAST TWO FLUID STREAMS, ELECTROCHEMICAL SYSTEM AND METHOD FOR PRODUCING A DEVICE WITH A HEAT TRANSFER ELEMENT”, filed Aug. 9, 2024, which is incorporated herein by reference. PCT application no. PCT/EP 2024/072655 claims priority to German patent application no. 10 2023 121 426.8, filed Aug. 10, 2023, which is incorporated herein by reference.

### BACKGROUND OF THE INVENTION

### 1. Field of the Invention

The present invention relates to a device for guiding fluid streams.

### 2. Description of the Related Art

Heat exchangers with monolithic bi-continuous core structures which are used for heat transfer between at least two fluids passing through the heat exchanger are known from the current state of the art. The core structure is intended to maximize the heat transfer surface or respectively the volume of the heat exchanger in order to improve the efficiency of heat transfer between the fluid streams passing through the heat exchanger. Known heat exchangers have at least one gyroidal structure with at least one main gyroid, which includes at least two independent labyrinths for the two fluid streams passing through the heat exchanger.

A heat exchanger of this type with a monolithic bi-continuous core structure including at least one non-intersecting surface by way of which two independent labyrinth volumes are defined is known for example, from U.S. Pat. No. 11,181,329 B2. By selecting suitable lattice parameters, the geometry of the core structure can be modified, which allows adjustment of the hydraulic diameter, surface density, flow rate, heat transfer, and pressure drop within the heat exchanger. The core geometry is generated by periodic repetition of an elementary cell geometry in the three different spatial directions. Fluid inlets into, and fluid outlets from, the at least two labyrinths are defined by the structural outer limits of the core structure of the heat exchanger. These are created by targeted covering or closing off or leaving open respective external areas for inlet and outlet of the two fluid streams.

For certain applications, such heat exchanger core structures also exhibit interleaved gyroidal structures consisting of a main gyroid and a secondary gyroid. The secondary gyroid, in particular, is formed within a main gyroid, also as a repeating cell structure, which may have a significantly lower lattice constant compared to the main gyroid.

The creation of such an interleaved gyroid is described, for example, in CN 112475319 B, where the main gyroid and the secondary gyroid have essentially the same lattice constants but different channel widths before intersection. Intersecting to form an interleaved gyroid structure creates a core structure that includes a first and a second channel system, which define the main gyroid, and moreover an interstitial space system, which is defined by the secondary gyroid, with a lower lattice constant than the channel systems. The first and second channel systems are spatially separated from each other by the interstitial space system.

The gyroidal structures described above typically exhibit a filigree design, which improves heat transfer efficiency but also makes them significantly more susceptible to static and dynamic loads. In particular, during the operation of such a device for guiding and/or heat transfer between two fluid streams by way of a heat transfer element including a gyroidal structure, undesirable deformations can occur due to vibrations and shocks during the flow of the fluid streams or due to differing pressure conditions in the channel systems. These deformations can ultimately lead to failure of the core structure, separation between the channel systems and the interstitial space system and mixing of the otherwise separately flowing fluids.

This is where the present invention comes into play. What is needed in the art is a device for guiding at least two fluid streams, wherein the disadvantages described above are avoided, and consequently increased structural integrity is achieved. In particular, what is needed in the art is a device for guiding fluids which offers at least an alternative further development of known devices.

In addition, what is needed in the art is to provide the device with regard to a heat exchanger not only or alternatively with regard to increased structural integrity but also or alternatively with regard to improved heat transfer, in particular between a process fluid and a heat exchange fluid.

### SUMMARY OF THE INVENTION

The present invention relates to a device for guiding of and/or heat transfer between at least two fluid streams, a process fluid and a heat exchange fluid, with a heat transfer element, wherein the heat transfer element hast a gyroidal structure with a main gyroid and a secondary gyroid intersecting to form an interleaved gyroid, with the creation of at least one first and second channel system, wherein the first and second channel system respectively have a first passage width and with the formation of an interstitial space system, wherein the interstitial space system has a second passage width, wherein the first and second channel system are spatially separated from the interstitial space system. The present invention also relates to an electrochemical system and a method for producing a device with a heat transfer element. The present invention provides according to a first aspect a device for guiding and/or transferring heat between at least two fluid streams, in particular a process fluid and a heat exchange fluid, of the type described above.

The present invention is based on a device for guiding and/or heat transfer between at least two fluid streams, a process fluid and heat exchange fluid, with a heat transfer element, wherein the heat transfer element has a gyroidal structure with a main gyroid and a secondary gyroid for intersecting in the form of an interleaved gyroid, with the creation of at least one first and second channel system, wherein the first and second channel system respectively have a first passage width and with the formation of an interstitial space system, wherein the interstitial space system has a second passage width, wherein the first and second channel system are spatially separated from the interstitial space system.

According to the present invention, the interstitial space system has a supporting structure that penetrates the interstitial space system.

In particular, the present invention proposes to equip a heat transfer element with an interleaved gyroid structure, including a main gyroid and a secondary gyroid with essentially the same lattice constant but different passage widths, which form a first and a second channel system and an interstitial space system spatially separated from the first and second channel systems, with a support structure penetrating the interstitial space system.

The present invention pursues the approach of reinforcing the interstitial space system by way of the supporting structure, so that static or dynamic loads are absorbed during the operation of the device according to the invention, that is, when flowing through the first and second channel systems and optionally also the interstitial space system with fluid streams being directed through the heat exchanger, thus effectively counteracting excessive deformation, in particular plastic deformation, of the gyroid structure. The inventive interleaved gyroid includes a main gyroid and a secondary gyroid, both of which have a substantially identical lattice constant. The main gyroid and secondary gyroid optionally have an almost identical lattice structure. The gyroids differ only in their relative passage width. A first and a second channel system are formed by way of the main gyroid. The secondary gyroid defines an interstitial space system by which the two channel systems are separated from each other. Even with differing pressure conditions within the first and second channel systems, and optionally also within the interstitial system, excessive deformation of the gyroidal structure of the heat exchanger is prevented by way of the support structure reinforcing the interstitial space system. Furthermore, the passage widths of the channel systems as well as the interstitial space system advantageously remain constant, which also has a beneficial effect on the efficiency of heat transfer in a device designed in this manner according to the present invention.

A further development of the present invention provides that the interstitial space system is limited in its passage width by walls and separated from the first and second channel systems. With the help of the walls, a structurally simple spatial separation of the interstitial space system from the adjacent first and second channel system is achieved. The support structure is optionally designed to keep the walls partitioning the interstitial space system in relation to each other in the second passage width. This efficiently counteracts the deformation of the gyroid structure of the heat exchanger. Depending on the geometric development of the gyroidal structure of the heat exchanger, the walls extend in any desired spatial direction, with the interstitial space system being designed as a kind of third labyrinth within the heat exchanger, which is always efficiently subdivided from the two channel systems by way of the walls.

According to an optional further development of the device, at least one of the walls is shared by the interstitial space system on the one hand and the first or second channel system on the other. Optionally, the heat transfer element is thus designed for heat transfer between the at least two fluid streams, in particular the process fluid and the heat exchange fluid. A wall limiting the interstitial system on one side optionally also limits one of the channel systems arranged adjacent to the interstitial space system, i.e., either the first or the second channel system. The interstitial space system and the first or second channel system thus respectively share a wall. The wall forms a fluid-impermeable barrier between the interstitial space system and the first or second channel system, thereby preventing the mixing of the fluid streams passing through the first and second channel systems and optionally also through the interstitial space system. Furthermore, the walls form a solid structure which, due to its physical properties, is inherently dimensionally stable. Dimensionally stable in this context means that the walls retain their existing shape under normal ambient conditions.

According to a further development, the first and second channel systems are optionally separated from each other by walls which are formed by the walls that limit the interstitial space system. It is provided in particular that a first wall is shared by the interstitial space system and the first channel system, and a second wall is shared by the interstitial space system and the second channel system. The walls separating the interstitial space system from the first and second channel systems are at the same time the walls that spatially separate the first and second channel systems and the fluid streams within them. The interstitial space system thus forms a labyrinth within a wall separating the first and second channel systems. This creates a type of double-walled structure. The first and second channel systems also extend through the heat exchanger in arbitrary spatial directions as a kind of labyrinth, thereby enabling efficient heat transfer between the fluid streams in the first and second channel systems and optionally the interstitial space system. In one possible further development of the present invention, one and the same fluid flows through the first and second channel systems, divided into two separate fluid streams. In an alternative design, two different fluids are guided through the first and second channel systems as separate fluid streams.

In another further development of the device, the second passage width of the interstitial space system is narrower than the first passage width. Specifically, the first passage width of the first and second channel systems respectively is either different from each other, or the same. The interstitial space system within the heat exchanger has a significantly smaller overall passage cross-section compared to the channel systems. By using different passage widths, the heat transfer can be precisely controlled, particularly when specific temperature differences need to be achieved by way of the heat exchangers. This makes it easy to ensure that the process fluid, which, for example, is passed through the interstitial space system, is either cooled to a sufficiently low temperature or heated to a sufficiently high temperature upon exiting the heat exchanger. Optionally, the heat exchange fluid is passed through the first and second channel systems, as its greater volume flow rate compared to the process fluid in the heat exchanger enables an effective temperature increase or decrease of the process fluid.

A further development of the device according to the present invention provides that the support structure includes a multitude of support elements, which extend between the wall surfaces of walls which limit the interstitial system and connect the walls with each other. The provision of a multitude of supporting elements as a support structure represents a structurally simple possibility for reinforcing the interstitial system and thus the gyroidal structure as a whole.

Optionally, it becomes possible in an improved manner to use the support elements to keep the distance between the walls limiting the interstitial space system constant, at least in some areas. The support struts of the support structure are optionally arranged at predetermined intervals from each other, wherein their spacing is selected so that, in the event of a pressure difference between the fluid streams conducted on the sides of a wall facing away from each other, only elastic deformation of the wall is permitted. This prevents plastic deformation of the wall and any resulting impairment of the gyroidal structure of the heat transfer element.

The support elements are optionally designed as support struts with a cross-section that remains constant in the direction of extension. The support elements, which optionally extend through the interstitial space system, cause turbulence within the fluid stream when a fluid passing through the heat exchanger flows through the interstitial space, thereby further increasing or improving heat transfer from the interstitial space system toward the adjacent first and second channel systems or toward the interstitial space system. The support elements can have any desired cross-section, such as circular or rectangular. In one possible further development, it is also conceivable that the cross-section of the support struts penetrating the interstitial space system varies in the direction of extension. The central region of a support strut, which is approximately midway between the walls limiting the interstitial space system, can be thicker, in particular in comparison to its ends.

Another further development provides that a rounded transition is created in the connecting region of a support element with a respective wall, thereby improving the transfer of forces into the support element and from the support element into the wall.

According to an optional further development of the device, the support elements extend essentially transversely, in particular perpendicular, to a respective adjacent surface of the wall. With the optionally vertical alignment of the support elements relative to the wall surfaces, an optimal transfer of force into and out of the support element and into the adjacent wall is achieved or further improved. Due to the optional perpendicular alignment relative to the wall surfaces, the walls are always connected with each other by the shortest route. Even with different pressures on wall surfaces facing away from each other and within the channel systems or interstitial space systems limited by them, a spatial displacement of the walls relative to each other and a possibly changing passage width and shear stresses in the connection areas between the supporting element and the wall are avoided.

According to an optional further development of the present invention, the first and second channel systems have walls limiting their passage width, the wall surfaces of which include a multitude of indentations that enlarge the surface of the walls, in particular the surface area of the wall surfaces; in other words, the first and second channel systems have walls limiting their passage width, the wall surfaces of which include a multitude of indentations, which increase the surface area of the walls, in particular the surface area of the wall surfaces.

By way of the indentations, an increase in surface area - in particular within the first and/or second channel system - is achieved which moreover improves the heat transfer between the channel systems and the interstitial space system. Originating from the wall surface, the indentations on the wall surface of the wall assigned to the first and second channel systems have a depth dimension that has a ratio <0.3 in relation to the width of the wall itself. This ensures that the indentations, which are formed on at least one side of the wall, optionally on the wall surface, which limit the passage width of the first and/or second channel system, do not result in a reduction in the strength of the wall itself.

According to one optional design, the indentations are designed as recesses in the material, which optionally have a circular shape with a concave curvature on the wall surface. Providing material recesses in the form of indentations is a structurally simple possibility of creating a wall surface with a constantly uneven surface, by way of which also turbulences are also generated for improved heat transfer. The material recesses have a circular shape at the level of the wall surface with a diameter that is at least half to approximately the entire width of the wall. The base of the material recesses optionally has a concave curvature. The indentations are optionally similar in shape to the indentations on the surface of a golf ball.

One optional embodiment of the device is characterized by at least two fluid inlets and outlets assigned to the heat transfer element, wherein the two fluid streams, optionally the process fluid and the heat exchange fluid, are directed in reverse flow direction through the heat transfer element. By directing the fluid streams through the heat transfer element in reverse flow direction in conjunction with the further development of the heat transfer element as an interleaved gyroid, the efficiency of heat transfer is further improved. Due to the further improved heat transfer, a heat transfer element with significantly reduced dimensions can be used to achieve the same heat transfer performance. This allows for advantageous material savings in the design of such heat transfer elements used for heat transfer.

Due to the separate formation of the first and second channel systems and the interstitial space system in the heat transfer element it is possible to pass three different fluids through the heat transfer element that is designed according to the present invention.

A further development provides that one and the same fluid, optionally the heat exchange fluid, is directed through the first and second channel systems, and the process fluid through the interstitial space system. The proportion of the volume of the heat exchange fluid flowing through the first and second channel systems is optionally approximately the same - and spatially separated from each other within the heat transfer element - even if the channels are arranged alternately.

Depending on the number of fluids used, the inventive device has at least two fluid inlets and two fluid outlets. If three different fluids are directed through the heat exchanger, three fluid inlets and three fluid outlets are required. To ensure that only the required channel/interstitial space system is supplied with the relevant fluid, corresponding inlet areas on the heat exchanger are left open to allow inflow of the fluid stream, and corresponding adjacent areas are covered or closed to impede inflow of the fluid stream.

According to an alternative further development, the heat transfer element is equipped respectively with three fluid inlets and fluid outlets assigned to it, wherein the heat exchange fluid in the first and second channel system is optionally directed in a counterflow to each other, and the process fluid in the interstitial space system is directed in a cross-flow relative to the heat exchange fluid. By directing at least one of the fluid streams in cross-flow to the at least one other fluid stream, a simplified fluid supply to the channel systems carrying the fluid streams and to the interstitial system is achieved. Introduction and discharge of the various fluid flows optionally takes place on wall areas that are turned away from each other, especially at right angles relative to each other, which further simplifies the introduction and discharge of different fluids to and from the heat exchanger.

According to a second aspect, the present invention relates to an electrochemical system including a fuel cell or an electrolyzer and at least one device according to one of the aforementioned further developments, for guiding at least two fluid streams, in particular a process fluid and a heat exchange fluid for heat transfer between the process fluid and a heat exchange fluid.

The present invention proposes, in an independent form according to the second aspect, to couple a device for guiding and/or transferring heat according to the features of the present invention described above with an electrochemical system including a fuel cell or an electrolyzer, in order to efficiently dissipate the heat generated during the operation of the fuel cell or electrolyzer, wherein heat transfer element of the device according to the present invention has increased structural strength in conjunction with improved efficiency in heat transfer due to the support structure penetrating the interstitial system.

The optional further developments of the device according to the present invention for guiding fluids and/or transferring heat between two fluids as described in the first aspect are, at the same time, also optional further developments of the electrochemical system according to the present invention, provided they do not contradict each other. Accordingly, the electrochemical system in its independent form has all the features listed as optional embodiments of the device, such as the walls separating the interstitial space system from the first and second channel systems, the plurality of support elements forming the support structure, and the indentations formed on the wall surface of the first and second channel systems for increasing the surface area, to name only at least one of the exemplary optional further developments.

According to a third aspect, the present invention relates to a method for manufacturing a device according to one of the further developments described above, with a heat transfer element, wherein the heat transfer element is manufactured using an additive manufacturing process.

Manufacturing using an additive manufacturing process, such as 3D printing, allows the heat transfer element to be produced as a single component. Thus, optionally all design features such as the support structure penetrating the interstitial space system or the indentations on the surfaces of the walls limiting the first and second channel system have been produced upon completion of the component.

The heat transfer element can thus be manufactured without any complex subsequent processing, although this cannot be ruled out. In particular, during subsequent processing, the wall areas limiting the external dimensions of the heat transfer element are prepared to form corresponding fluid inlets and fluid outlet. For this purpose, inlet areas, for example to the second channel system/interstitial space system which are not intended as fluid inlets in this region are sealed off in the fluid inlet to the first channel system with assistance of cover elements designed for this purpose. Alternatively, such sealed areas can also be created using additive manufacturing processes.

The heat transfer element is optionally manufactured from aluminum (advantage: light) or copper (better thermal conductivity); in other words, the interleaved gyroid consists in particular of aluminum or copper.

Embodiments and arrangements of the invention are described below with reference to the drawings and in comparison to state of the art, which is also partially illustrated. This is not intended to necessarily be to scale; rather, where useful for clarification, drawings are presented in a schematic and/or slightly distorted form. With regard to additions to the teachings immediately apparent from the drawing, reference is made to the relevant state of the art. It should be noted that diverse modifications and changes concerning the shape and details of an embodiment can be made without deviating from the general idea of the invention. The features of the invention disclosed in the description, the drawings, and the claims can be essential for the further development of the invention, both individually and in any combination. Moreover, all combinations of at least two of the features disclosed in the description, the drawings, and/or the claims fall within the scope of the invention. The general idea of the invention is not limited to the exact form or detail of the optional embodiment shown and described below, nor is it limited to an object that would be restricted compared to the object claimed in the claims. For specified design ranges, values within the stated limits shall also be disclosed as limit values and may be used and claimed as desired.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a heat transfer element according to the invention;

FIG. 2 is a sectional detailed view of a heat transfer element according to the invention;

FIG. 3 is a perspective view of a first embodiment of a device according to the invention with a heat transfer element;

FIG. 4 is a perspective view of a second embodiment of a device according to the invention with a heat transfer element; and

FIG. 5 is a schematic presentation of an electrochemical system with a device according to the invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

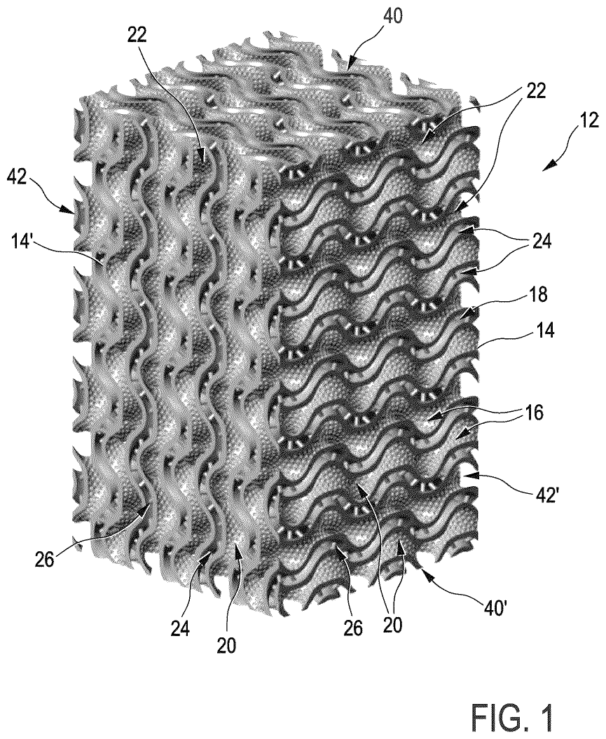

FIG. 1 shows a perspective view of a heat transfer element 12 for a device 10 for guiding at least two fluid streams FS_{1,2,3}, in particular a process fluid and a heat exchange fluid.

In the current example the gyroid structure serves also as a heat exchanger. In a heat exchanger, heat is transferred from one medium of higher temperature to another medium, or one with identical properties, of lower temperature.

The heat exchanger in this example is a heat transfer element 12, that has a gyroidal structure 14, formed as a nested gyroid 14′, consisting of a main gyroid 16 and a secondary gyroid 18. The intersection of the main gyroid 16 and the secondary gyroid 18 creates a first channel system 20 and a second channel system 22 as well as an interstitial space system 24 spatially separated from the first and second channel systems 20, 22.

Thus, the media of fluid streams FS_{1,2,3}, in particular a process fluid and a heat exchange fluid, are spatially separated from each other by a partition wall. During transfer, heat is first transferred from a warmer medium to the partition wall, passed through the partition wall and then transferred from the partition wall to a colder medium. Such heat transfer therefore includes thermal energy transportation from the one medium through the partition wall, again to the other medium and determines the performance quality of the heat exchanger. If this heat transfer performance is to be increased, this can be achieved by increasing the separation surfaces of the partition wall, as both media have available a larger exchange surface for the transfer of thermal energy.

By way of an interleaved gyroid—formed by intersection of main gyroid 16 and secondary gyroid 18—the exchange surface area can be significantly increased, and the amount of heat transferred in the heat exchanger can be increased without increasing the installation space. Optionally, a gyroid of the same size but having a thinner wall thickness is intersected. This so-called Boolean intersection creates an additional flow space. This promotes energy transportation between the media; a more compact installation space is created at the same heat exchanger performance.

Specifically, according to the present optional design, first and second channel systems 20, 22 are spatially separated from each other; interstitial system 24 is also spatially separated from first and second channel systems 20, 22. First and second channel systems 20, 22 have a passage width DW₁, and interstitial space system 24 has a second passage width DW₂. As can be seen in FIG. 1, second passage DW₂ of interstitial space system 24 is narrower than first passage DW₁ of the first and second channel systems 20, 22.

According to the concept of the present invention, interstitial space system 24 has, as can be seen from FIG. 1, a support structure 26 that penetrates interstitial space system 24, which provides both interstitial space system 24 and gyroidal structure 14 with increased strength and thus stabilization. Gyroid structure 14, which is designed as an interleaved gyroid 14′, has walls 28, 30, which separate first and second channel systems 20, 22 from each other and also separate interstitial space system 24 from first and second channel systems 20, 22.

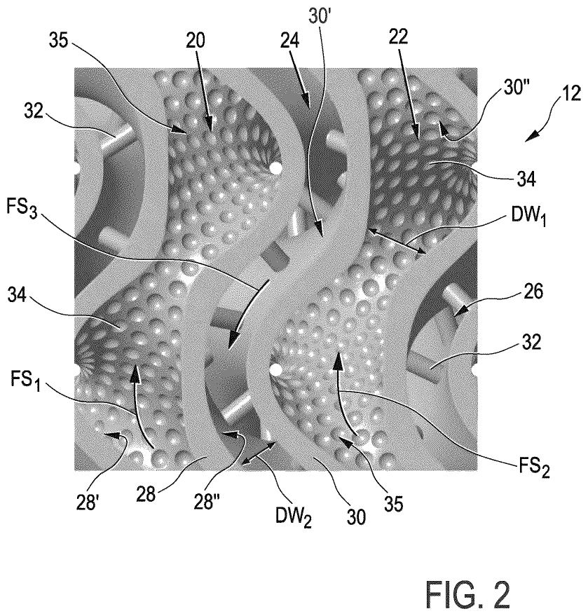

FIG. 2 shows an enlarged sectional detailed view of gyroid structure 14′, which illustrates the spatial design of channel systems 20, 22 and interstitial space system 24. Both, the first and second channel systems 20, 22 and interstitial space system 24 interspersed with support structure 26 each form a labyrinth system or labyrinth channels within heat transfer element 12, through which at least two fluid streams FS_{1,2,3} are directed for corresponding heat transfer between the fluid streams.

Walls 28, 30 respectively limit the two channel systems 20, 22 as well as interstitial space system 24 in their respective opening widths DW₁, DW_{2.} Interstitial space system 24 and first and second channel systems 20, 22 respectively share one of the walls 28, 30, meaning that fluid FS₃ flowing through interstitial space system 24 is in contact with wall surface 28″, 30′ of walls 28, 30, and that the fluid flowing in first and second channel systems 20, 22 is directed on the opposite wall surface 28′, 30″ of walls 28, 30.

It can also be seen from FIG. 2 that support structure 26 has a multitude of support elements 32, which extend between walls 28, 30, in particular wall surfaces 28″, 30′. In particular, walls 28, 30 are connected to each other by supporting elements 32 and are thus supported relative to each other.

In the current example, support elements 32 of support structure 26 are designed as struts; they can however also be designed different or vary from the struts shown. Support elements 32 are basically designed according to the concept of the present invention to provide heat transfer element 12 an increased structural integrity, in particular to improve the mechanical stability of heat transfer element 12.

In addition, support elements 32 of support structure 26 have proven to be

advantageous, as they penetrate the interstitial space system. Basically, support elements 32 are designed and arranged to generate a turbulence in the fluid flowing in interstitial space system 24, namely in process fluid FS_{3,} to at least mix it and/or to throw it onto opposite wall surfaces 28′, 30″ of walls 28, 30, thereby increasing or improving the heat transfer during operation of the heat exchanger.

Support elements 32 in the present example are arranged at a specified distance from each other. Optionally, the distance between two support elements 32 to each other corresponds to approximately the greatest passage width DW₁ₘₐₓ of first and second channel systems 20, 22.

As further illustrates in FIG. 2, passage width DW₂ of interstitial system 24 is essentially constant. It can vary within a range of +/−10 to 15 % in relation to average passage width DW₂. The passage width of first and second channel systems 20, 22 varies in a range of DW₁ₘᵢₙ to DW₁ₘₐₓ, wherein the maximum first passage width DW₁ₘₐₓ is about three times the minimum first passage width DW₁ₘᵢₙ. Passage width DW₂ corresponds to about one third of the average passage width DW₁.

In one optional arrangement, support elements 32 are designed as support struts 32′. Optionally, support elements 32 designed as support struts 32′ have an approximately constant cross-section in the direction of extension. In addition, support elements 32 extend substantially transversely, in particular perpendicularly to an adjacent area of wall surfaces 28″, 30′ of walls 28, 30.

According to one optional arrangement, as also shown in FIG. 2, first and second channel systems 20, 22 have a multitude of indentations 34 on their wall surfaces 28′, 30″ which limit passage width DW₁ and increase the surface area of walls 28, 30; in other words, first and second channel systems 20, 22 have walls 28, 30 which limit their passage width DW₁ and the wall surfaces 28′, 30″ of which include a multitude of indentations 34 which increase the surface area of walls 28, 30, in particular the surface area of wall surfaces 28′, 30″.

In the present example, such depressions 34 are optionally designed as material recesses on wall surfaces 28′, 30″ of walls 28, 30 and have an optionally circular shape with a concavely curved surface 35. In the current example, depressions 34 form a golf ball structure on corresponding wall surface 28′, 30″. This design has the advantage of improving heat transfer because the depressions increase the heat transfer surface area.

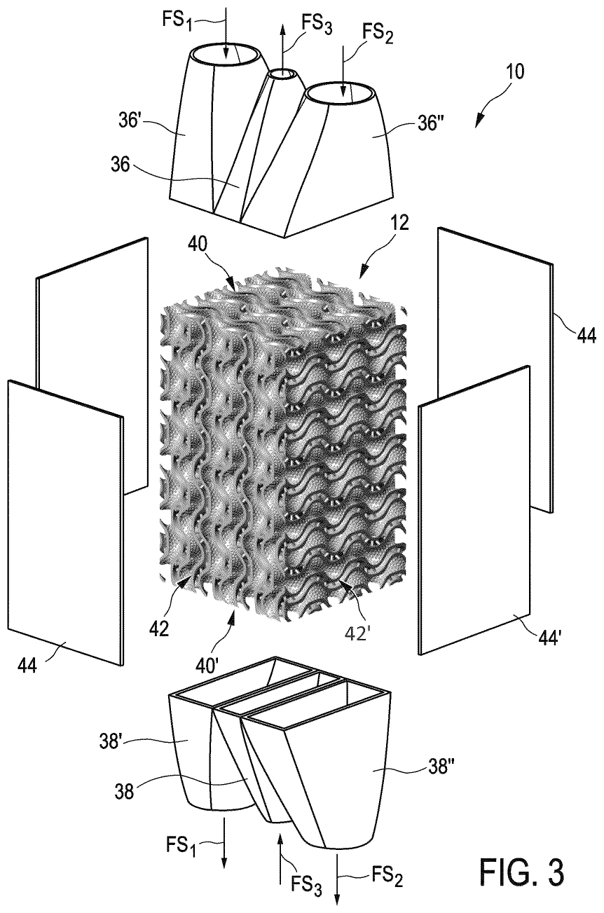

FIG. 3 shows a first embodiment of a device 10 according to the present invention for guiding and transferring heat between at least two fluid flows FS_{1,2,3}, in particular three separately guided fluid flows FS_{1,2,3}. Device 10 includes a heat transfer element 12 having the gyroidal structure 14 according to the present invention, which is described in more detail in FIGS. 1 and 2. Device 10 includes three fluid inlets 36, 36′, 36″ and three fluid outlets 38, 38′, 38″ for the three fluid streams FS_{1,2,3} which are guided through heat transfer element 12.

The heat transfer element 12 has the shape of a cuboid, which in the present design example has square end faces 40, 40′ and four equally sized 42, 42′ side faces. Side faces 42, 42′ of heat transfer element 12 are sealed by side walls 44, 44′. The flow of fluid streams FS_{1,2,3} into and out of heat transfer element 12 occurs via end faces 40, 40′. Respective fluid inlets and outlets 36-38″ are only connected to certain areas of end faces 40, 40′ in a fluid-conducting manner, which lead to corresponding channel systems 20, 22 or respectively to interstitial space system 24. Areas on end surfaces 40, 40′ of heat transfer element 12, which are not exposed to fluid stream FS_{1,2,3} are then closed. Only the channel system or interstitial system which is actually supposed to communicate with the corresponding fluid inlet or fluid outlet 36-38″ is designed to be open.

In the embodiment shown in FIG. 3, fluid streams FS_{1,2,3} are directed in counterflow direction relative to each other.

In particular, process fluid FS₃ is introduced into heat transfer element 12 from lower end face 40′ via central fluid inlet 36, and heat exchange fluid FS_{1,2} is introduced into heat transfer element 12 from upper end face 40 via fluid inlets 36′, 36″. In the current example, the fluid streams introduced via fluid inlets 36′, 36″ are one and the same fluid. However, different fluids could also be used via fluid inlets 36′, 36″ to cool the upwardly directed process fluid FS₃.

In particular, fluid inlet 36 and fluid outlet 38 are coupled to interstitial system 24 in a fluid-conducting manner, in the present case for guiding of process fluid FS₃. Outer fluid inlets and outlets 36′, 36″, 38′, 38″ are respectively connected to first and second channel systems 20, 22 in a fluid-conducting manner, in other words, in the present case for guiding heat exchange fluid FS_{1,2}.

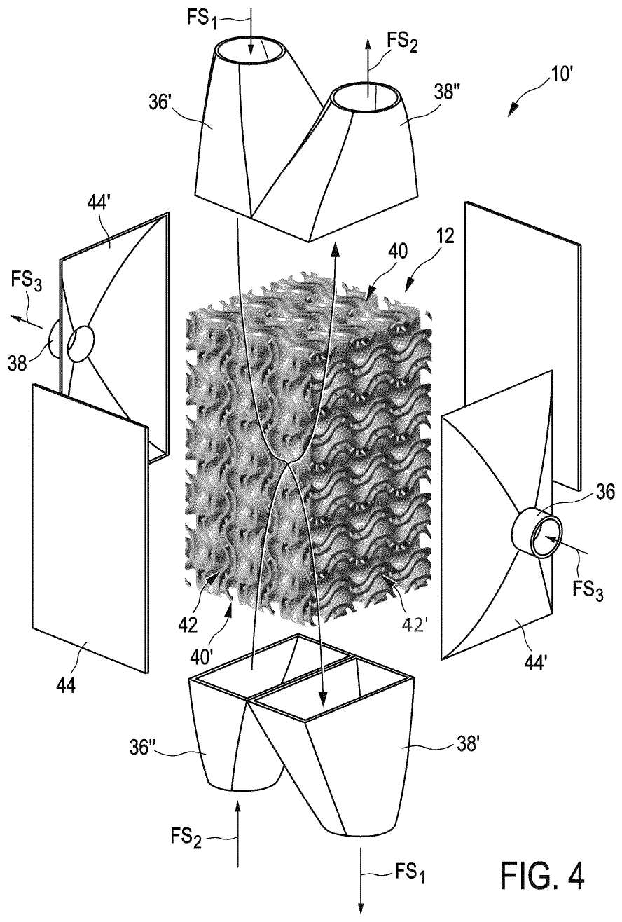

FIG. 4 shows a further embodiment of a device 10′ according to the present invention for guiding and transferring heat between three fluid streams FS_{1,2,3}. Device 10′ also includes a heat transfer element 12, which includes a gyroidal structure 14 designed according to the present invention.

In contrast to the previous embodiment, end faces 40, 40′ of the heat transfer element 12 are only connected to two fluid inlets 36′, 36″ and two fluid outlets 38′, 38″ in a fluid-conducting manner, that is, in the present example, for the purpose of guiding heat exchange fluid FS_{1,2}. In the present arrangement, fluid inlet 36 and fluid outlet 38 for third fluid stream FS₃ are arranged on side walls 44′ and thus assigned to two opposite side surfaces 42′ of heat transfer element 12. In particular, fluid inlet and outlet 36, 38 are connected in a fluid-conducting manner to interstitial space system 24 for guiding fluid stream FS₃, that is, in the present example, for the purpose of guiding process fluid FS₃.

Side surfaces 42′ adjacent to inlet and outlet 36, 38 are closed in a sealed manner by side walls 44.

Also in this arrangement, respective inlets 36 and outlets 38″ are connected to the respective assigned surface areas of heat transfer element 12 in a fluid-conductive manner, so that fluid streams FS_{1,2,3} only flow into channels 20, 22 or spaces 24 provided for this purpose.

Fluid stream FS₃ flowing into heat transfer element 12 via fluid inlet 36 and fluid outlet 38 is directed through interstitial space system 24 of heat transfer element 12. Fluid streams FS_{1,2}—in this example, the heat exchange fluid—which are directed through heat transfer element 12 via fluid inlets 36′, 36″ and fluid outlets 38′, 38″ are directed through heat transfer element 12 via first and second channel systems 20, 22.

Fluid streams FS₁ and FS₂ flow in opposite direction to each other. Fluid stream FS₃ flows approximately at a right angle relative to fluid streams FS₁ and F₂ in a crossflow direction.

Heat transfer element 12 used in device 10, 10′ is designed in particular, to be produced in an additive manufacturing process, such as a 3D printing process.

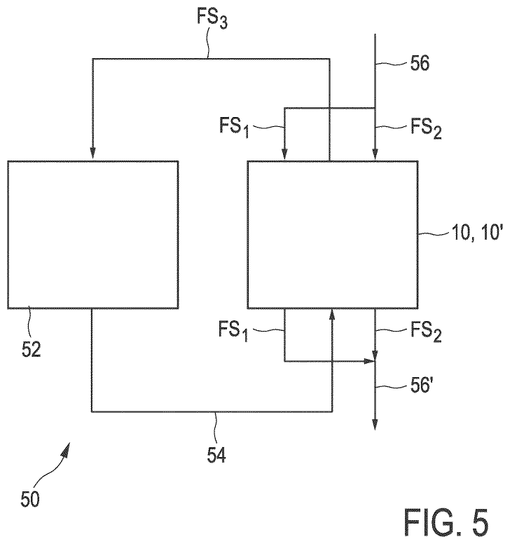

FIG. 5 shows an electrochemical system 50 including a fuel cell or electrolyzer 52 and a device 10, 10′ for guiding and transferring heat between at least two fluid streams FS_{1,2,3}, which is designed according to at least one of the arrangements described above. The fuel cell or electrolyzer 52 can be coupled with device 10, 10′ in a fluid conducting manner via a fluid line 54, which in this example is designed as a closed loop line. The process fluid flows in fluid line 54 in the form of fluid stream FS₃, which is to be heated to a required temperature within device 10, 10′ before being fed again to fuel cell or electrolyzer 52.

In addition, at least one heat exchange fluid in the form of fluid stream FS_{1,2} is supplied to device 10, 10′ via fluid lines 56, 56′ and discharged again, by way of which process fluid (FS₃) is brought to the required temperature level, optionally cooled down. The distribution of heat exchange fluid (FS_{1,2}) which is supplied and discharged via lines 56, 56′ to fluid inlets 36′, 36″, 38′, 38″, which are shown in more detail in FIGS. 3 and 4, occurs via device 10, 10′ itself.

### COMPONENT IDENTIFICATION LIST

10, 10′ Device

12 heat transfer element

14 gyroidal structure

14′ interleaved gyroid

16 main gyroid

18 secondary gyroid

20 first channel system

22 second channel system

24 interstitial system

26 support structure

28, 30 wall

28′, 28″ wall surface

30′, 30″ wall surface

32 support element

32′ support struts

34 indentation

35 curved surface

36, 36′, 36″ fluid inlet

38, 38′, 38″ fluid outlet

40, 40′ end face

42, 42′ side face

44, 44′ side walls

50 electrochemical system

52 fuel cell/electrolyzer

54 fluid ring line

56, 56′ fluid line

DW₁ passage width

DW₂ passage width

FS₁ first fluid stream, in particular heat exchange fluid

FS₂ second fluid stream, in particular heat exchange fluid

FS₃ third fluid stream, in particular process fluid

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for guiding at least two fluid streams, the device comprising:
a heat transfer element, which includes a gyroidal structure, which includes a main gyroid and a secondary gyroid intersecting to form an interleaved gyroid thereby forming at least a first channel system and a second channel system and an interstitial space system, the first channel system and the second channel system each including a first passage width, the interstitial space system including a second passage width, the first channel system and the second channel system being spatially separated from the interstitial space system, the interstitial space system including a support structure that penetrates other portions of the interstitial space system.

2. The device according to claim 1, wherein the heat transfer element includes a plurality of walls, wherein the interstitial space system is limited in the second passage width of the interstitial space system by the plurality of walls, and the interstitial space system is separated from the first channel system and the second channel system.

3. The device according to claim 2, wherein at least one of the plurality of walls is shared by the interstitial space system and the first channel system or the second channel system.

4. The device according to claim 2, wherein the at least one of the plurality of walls is configured for heat transfer between the at least two fluid streams.

5. The device according to claim 2, wherein the first channel system and the second channel system are separated from each other by the plurality of walls, which are formed by the plurality of walls that limit the interstitial space system.

6. The device according to claim 5, wherein the plurality of walls include a first wall and a second wall, wherein the first wall is shared by the interstitial space system and the first channel system, and the second wall is shared by the interstitial space system and the second channel system.

7. The device according to claim 2, wherein the second passage width of the interstitial space system is narrower than the first passage width.

8. The device according to claim 2, wherein the plurality of walls includes a plurality of wall surfaces, wherein the support structure includes a plurality of support elements, which extend between the plurality of wall surfaces of the plurality of walls limiting the interstitial space system and which connect the plurality of walls with each other.

9. The device according to claim 8, wherein the plurality of support elements are formed as a plurality of support struts with respectively a cross-section that remains constant in a direction of extension.

10. The device according to claim 8, wherein the plurality of support elements extend essentially transversely to respective adjacent ones of the plurality of wall surface of the plurality of walls respectively.

11. The device according to claim 8, wherein the plurality of support elements extend essentially perpendicularly to respective adjacent ones of the plurality of wall surface of the plurality of walls respectively.

12. The device according to claim 1, wherein the first channel system and the second channel system include a plurality of walls limiting the first passage width, the plurality of walls including a plurality of wall surfaces which include a plurality of indentations that enlarge the plurality of wall surfaces of the plurality of walls.

13. The device according to claim 12, wherein the plurality of indentations enlarge a surface area of the plurality of wall surfaces.

14. The device according to claim 12, wherein the plurality of indentations are formed as a plurality of recesses in a material of the plurality of wall surfaces.

15. The device according to claim 14, wherein the plurality of recesses have a circular configuration on the plurality of wall surfaces with respectively a concave surface.

16. The device according to claim 1, wherein the device further includes at least two fluid inlets and at least two fluid outlets which are assigned to the heat transfer element, wherein the at least two fluid streams are directed in reverse flow direction.

17. The device according to claim 16, wherein the at least two fluid inlets are three fluid inlets assigned to the heat transfer element and the at least two fluid outlets are three fluid outlets assigned to the heat transfer element.

18. The device according to claim 17, wherein the device is configured for guiding the at least two fluid streams, which include a process fluid and a heat exchange fluid, wherein the device is configured such that the heat exchange fluid in the first channel system and the second channel system is directed in a counterflow to each other and such that the process fluid in the interstitial space system is directed in a cross-flow relative to the heat exchange fluid.

19. An electrochemical system, comprising:
a fuel cell or an electrolyzer; and
at least one device for guiding at least two fluid streams, the at least one device being operatively coupled with the fuel cell or the electrolyzer, the at least one device including a heat transfer element, which includes a gyroidal structure, which includes a main gyroid and a secondary gyroid intersecting to form an interleaved gyroid thereby forming at least a first channel system and a second channel system and an interstitial space system, the first channel system and the second channel system each including a first passage width, the interstitial space system including a second passage width, the first channel system and the second channel system being spatially separated from the interstitial space system, the interstitial space system including a support structure that penetrates other portions of the interstitial space system.

20. A method for manufacturing a device, the method comprising the steps of:
manufacturing the device, the device being for guiding at least two fluid streams, the device including a heat transfer element, which includes a gyroidal structure, which includes a main gyroid and a secondary gyroid intersecting to form an interleaved gyroid thereby forming at least a first channel system and a second channel system and an interstitial space system, the first channel system and the second channel system each including a first passage width, the interstitial space system including a second passage width, the first channel system and the second channel system being spatially separated from the interstitial space system, the interstitial space system including a support structure that penetrates other portions of the interstitial space system, the heat transfer element being manufactured using an additive manufacturing process.
